(19) United States
(12) Patent Application Publication
(10) Pub. No.: US 2024/0283158 A1
(43) Pub. Date: Aug. 22, 2024

(54) DIELECTRIC WAVEGUIDE ANTENNA ARRAY

(71) Applicant: ELECTRONIC DESIGN & DEVELOPMENT, CORP., Tucson, AZ (US)

(72) Inventors: Sergio E. Cardona, JR., Tucson, AZ (US); Kevin W. Patrick, Tucson, AZ (US); Joel Blumke, Tucson, AZ (US)

(21) Appl. No.: 18/594,328

(22) Filed: Mar. 4, 2024

Related U.S. Application Data
(63) Continuation-in-part of application No. 18/582,423, filed on Feb. 20, 2024.
(60) Provisional application No. 63/485,974, filed on Feb. 20, 2023.

(51) Int. Cl. H01Q 9/04; H01Q 21/00

(52) U.S. Cl. CPC H01Q 9/0485; H01Q 21/0068

(57) ABSTRACT

A signal transmission device comprising a phased array comprising a plurality of dielectric antennas. The device may be configured to generate a signal having a beam profile based on one or more properties of the plurality of dielectric antennas. The one or more properties may comprise a height of one or more antennas of the plurality of dielectric antennas, a distance between the plurality of dielectric antennas, or a combination thereof.

### CROSS-REFERENCES TO RELATED APPLICATIONS

This application is a continuation-in-part and claims benefit of U.S. patent application Ser. No. 18/582,423, filed Feb. 20, 2024, which claims benefit of U.S. Provisional Patent Application No. 63/485,974, filed Feb. 20, 2023, the specifications of which are incorporated herein in their entirety by references.

### FIELD OF THE INVENTION

The present invention is directed to a phased array of dielectric waveguide antennas for achieving various beam profiles.

### BACKGROUND OF THE INVENTION

High-gain antennas are useful for wireless communication with high signal strength. However, constructing such antennas with a desired antenna pattern comes with a multitude of deficiencies that manufacturers aim to minimize, such as limited bandwidth. Another of these deficiencies is the presence of side lobes, the directional radiation pattern of the antenna that results in energy being radiated in unintended directions.

These side lobes can lead to reduced antenna gain due to the energy radiating away from the desired direction, meaning that less energy is being radiated in the intended direction reducing the gain of the antenna. Additionally, the energy radiated or received by the side loves can interfere with other nearby antennas or systems or pick up energy from nearby systems, causing interference and reducing the overall performance of all affected systems. The unintended radiation from the side lobes can also allow eavesdropping on sensitive transmissions or communications, which can pose a security risk. Furthermore, when the energy is radiated in unintended directions, it can bounce off obstacles and arrive at the receiver at different times, reducing the signal-to-noise ratio and making it difficult to distinguish the desired signal from noise.

Several solutions to these issues have been proposed to remedy these problems, however, these solutions come with their own deficiencies. Dish antennas and parabolic antennas are expensive and overly large, and while horn antennas are able to solve the size issue, the cost issue is still present. Most recently, phased arrays have been the primary solution to the aforementioned issues.

Typically, these phased arrays take the form of a phased array antenna system with patch antennas. A patch antenna is a type of directional antenna commonly used in wireless communication systems. It is a type of microstrip antenna that consists of a thin rectangular metal patch that is printed or etched onto a substrate, typically made of fiberglass or a similar material. The patch is usually placed over a ground plane, which is typically a larger metal surface on the other side of the substrate. The operating frequency of a patch antenna is determined by its physical dimensions, which are typically a fraction of the wavelength of the operating frequency. The patch is excited by a feed line that is connected to a transmission line or a coaxial cable. The shape and size of the patch, as well as the distance between the patch and the ground plane, can be adjusted to optimize the performance of the antenna, such as the impedance matching, the gain, and the radiation pattern. However, this implementation still suffers from deficiencies in low bandwidth, low gain, and a lack of variability in beam profiles. Thus, there exists a present need for an efficient phased array system implementing the configurability of patch antennas for variable beam profiles.

### BRIEF SUMMARY OF THE INVENTION

It is an objective of the present invention to provide systems that allow for a phased array of dielectric waveguide antennas for achieving various beam profiles, as specified in the independent claims. Embodiments of the invention are given in the dependent claims. Embodiments of the present invention can be freely combined with each other if they are not mutually exclusive.

The present invention implements an array-style design which allows the system to benefit from the interference properties of waves when controlled. However, unlike typical arrays that use patch antennas, the present invention implements dielectric waveguide antennas (DWA). DWAs have the benefits of higher gain, lower loss, and wide bandwidth. The higher gain allows for the transmission and reception of signals over longer distances with higher signal strength, making them suitable for long-range communication applications. The low loss of DWAs allows for the transmission and reception of signals with less attenuation, resulting in better signal quality and higher efficiency. The wider bandwidth allows for operation over a broader range of frequencies, making them suitable for applications that require the transmission and reception of signals over a wide range of frequencies.

The present invention features a signal transmission device. The device may comprise a phased array comprising a plurality of dielectric antennas. The device may be configured to generate a signal having a beam profile based on one or more properties of the plurality of dielectric antennas. The one or more properties may comprise a height of one or more antennas of the plurality of dielectric antennas. In some embodiments, the one or more properties may comprise a distance between the plurality of dielectric antennas.

The present invention features a method for assembling a signal transmission device. The method may comprise determining an intended beam profile based on a desired application and fabricating a board comprising a plurality of pedestals. A distance between the plurality of pedestals may be based on the intended beam profile. The method may further comprise attaching a plurality of dielectric antennas to the plurality of pedestals such that a dielectric antenna is attached to each pedestal of the plurality of pedestals to form a phased array. A height of each antenna of the plurality of dielectric antennas may be based on the intended beam profile.

One of the unique and inventive technical features of the present invention is the implementation of dielectric antennas in a phased array. Without wishing to limit the invention to any theory or mechanism, it is believed that the technical feature of the present invention advantageously provides for a high-gain, low-loss, and wide bandwidth signal transmission system that minimizes side lobes. None of the presently known prior references or work has the unique inventive technical feature of the present invention.

Furthermore, the inventive technical features of the present invention contributed to a surprising result. For example, one of ordinary skill in the art would find that the size constraints of dielectric antennas would make them unsuitable for most applications when compared to prior patch antenna systems. The present invention implements a phased array of dielectric antennas with antenna heights that vary according to the given application. Surprisingly, this allows for the presently claimed invention to be sized according to the necessary application, and the implementation of a phased array of dielectric antennas prevents the gain and bandwidth of the system from suffering from smaller sizes. Thus, the inventive feature of the present invention contributed to a surprising result.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1A shows a side view of the signal transmission device of the presently claimed invention.

FIG. 1B shows a top view of the signal transmission device of the presently claimed invention.

FIG. 2 shows a flow chart of a method for assembling the signal transmission device of the present invention.

FIG. 3A shows a diagram of a single slot feed line for a dielectric antenna of the device of the present invention.

FIG. 3B shows a diagram of a dual slot feed line with a center metal post for a dielectric antenna of the present invention.

FIG. 4 shows a diagram of a distribution circuit with slot feeds of the device of the present invention.

FIG. 5A shows a schematic of the array board of the device of the present invention.

FIG. 5B shows a layout of the isolated circuit contained in the array board shown in FIG. 5A.

FIG. 6A shows a photograph of a bare network feed circuit card comprising a plurality of pedestals.

FIG. 6B shows a photograph of a closeup of a pedestal implemented on the board of the present invention.

FIG. 6C shows a photograph of a completed embodiment of the signal transmission device of the present invention.

FIG. 7A shows a first example of signal transmission with power contouring as implemented in the present invention.

FIG. 7B shows a second example of signal transmission with power contouring as implemented in the present invention.

FIG. 7C shows a third example of signal transmission with power contouring as implemented in the present invention, showing an example of the change in factors of power applied to the central antennas compared to the outer antennas.

FIG. 8A shows a top-down diagram of the array board of the present invention.

FIG. 8B shows a close-up top-down diagram of a pedestal of the array board of the present invention.

FIG. 8C shows a side-view diagram of the array board of the present invention.

FIG. 9A shows a side-view diagram of a dielectric antenna of the present invention.

FIG. 9B shows a close-up diagram of a base of the dielectric antenna of the present invention.

FIG. 9C shows a top-down diagram of the dielectric antenna of the present invention.

### DETAILED DESCRIPTION OF THE INVENTION

Following is a list of elements corresponding to a particular element referred to herein:
100 device
110 dielectric antennas
200 board
210 pedestals

The term “beam profile” is defined herein as the 2D intensity plot of a beam at a given location along the beam path.

The term “bilateral gradient” is defined herein as an amount of power directed to a row of antennas that is greatest in the center and lowest at both ends of the row. The amount of power directed to each antenna gradually gets smaller the closer each antenna is to each end.

The term “phased array” is defined herein as a group of sensors located at distinct spatial locations in which the relative phases of the sensor signals are varied in such a way that the effective propagation pattern of the array is reinforced in a desired direction and suppressed in undesired directions.

Note that the terms “antenna” and “rod” may be used interchangeably herein.

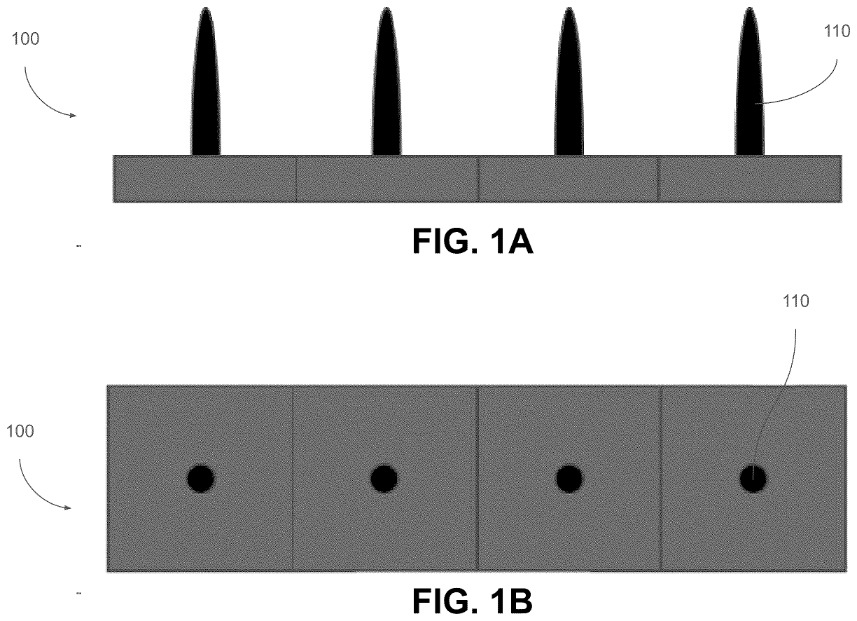

Referring now to FIGS. 1A-1B, the present invention features a signal transmission device (100). In some embodiments, the device (100) may comprise a phased array comprising a plurality of dielectric antennas (110). The device (100) may be configured to generate a signal having a beam profile based on one or more properties of the plurality of dielectric antennas (110). In some embodiments, the one or more properties may comprise a height of one or more antennas of the plurality of dielectric antennas (110). In some embodiments, the one or more properties may comprise a distance between the plurality of dielectric antennas (110).

In some embodiments, the one or more properties may comprise an amount of power directed to each antenna of the plurality of dielectric antennas (110). In some embodiments, the amount of power directed to the plurality of dielectric antennas (110) may comprise a bilateral gradient such that the amount of power directed to antennas at each end of the phased array is less than the amount of power directed to antennas at a center of the phased array. In some embodiments, the beam profile may be further affected by a dielectric constant of each antenna of the plurality of dielectric antennas (110).

In some embodiments, one or more antennas of the plurality of dielectric antennas (110) may be configured to be fed by a slot. In some embodiments, one or more antennas of the plurality of dielectric antennas (110) may be configured to be fed by two slots. In some embodiments, each antenna of the one or more antennas configured to be fed by two slots may comprise a center post disposed between the two slots. In some embodiments, the plurality of dielectric antennas (110) may be arranged in one or more rows such that a perimeter around the plurality of dielectric antennas (110) has a rectangular shape. In some embodiments, the plurality of dielectric antennas (110) may comprise 4 to 20 antennas.

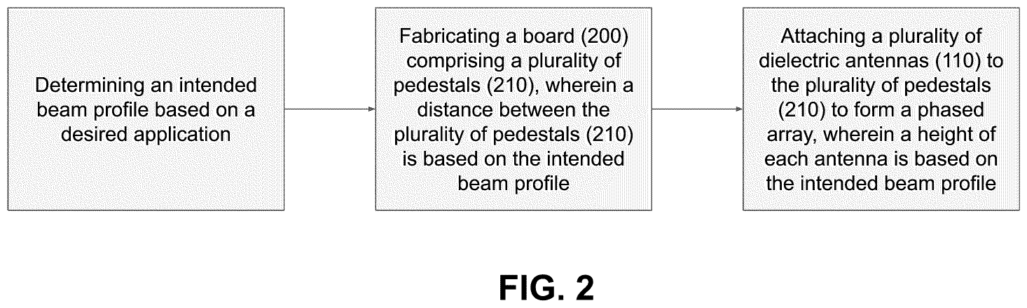

Referring now to FIG. 2, the present invention features a method for assembling a signal transmission device (100). In some embodiments, the method may comprise determining an intended beam profile based on a desired application and fabricating a board (200) comprising a plurality of pedestals (210). A distance between the plurality of pedestals (210) may be based on the intended beam profile. The method may further comprise attaching a plurality of dielectric antennas (110) to the plurality of pedestals (210) such that a dielectric antenna is attached to each pedestal of the plurality of pedestals (210) to form a phased array. A height of each antenna of the plurality of dielectric antennas (110) may be based on the intended beam profile.

In some embodiments, the method may further comprise directing an amount of power to each antenna of the plurality of dielectric antennas (110) based on the intended beam profile. In some embodiments, the amount of power directed to the plurality of dielectric antennas (110) may comprise a bilateral gradient such that the amount of power directed to antennas at each end of the phased array is less than the amount of power directed to antennas at a center of the phased array. In some embodiments, a dielectric constant of each antenna of the plurality of dielectric antennas (110) may be based on the intended beam profile.

In some embodiments, the board (200) may further comprise a plurality of slots such that a slot feeds each pedestal of the plurality of pedestals (210). In some embodiments, the board (200) may further comprise a plurality of slots such that two slots feed each pedestal of the plurality of pedestals (210). In some embodiments, the board (200) may further comprise a plurality of center posts such that, for each pedestal, a center post is disposed between the two slots. In some embodiments, the plurality of pedestals (210) may be arranged in one or more rows such that a perimeter around the plurality of pedestals (210) has a rectangular shape.

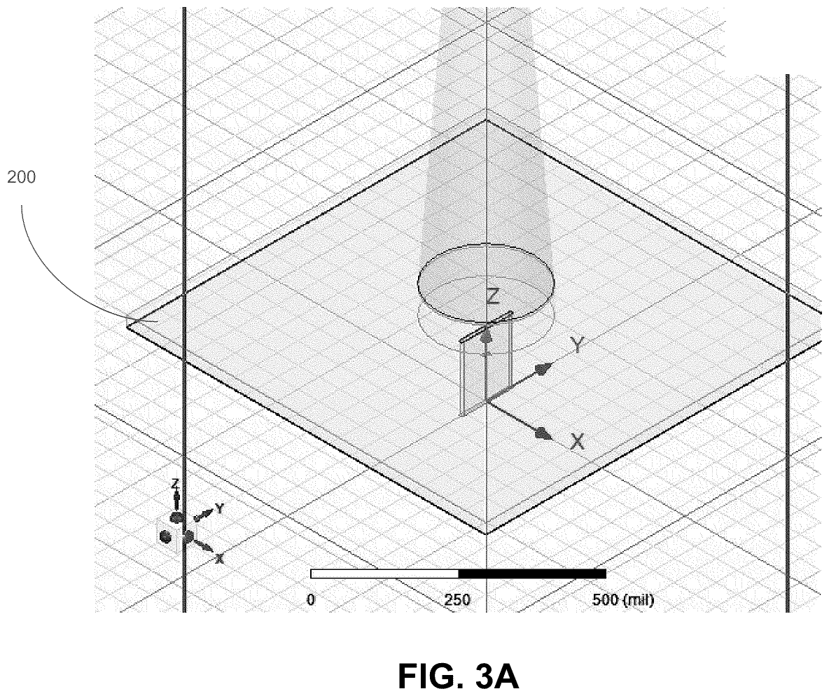

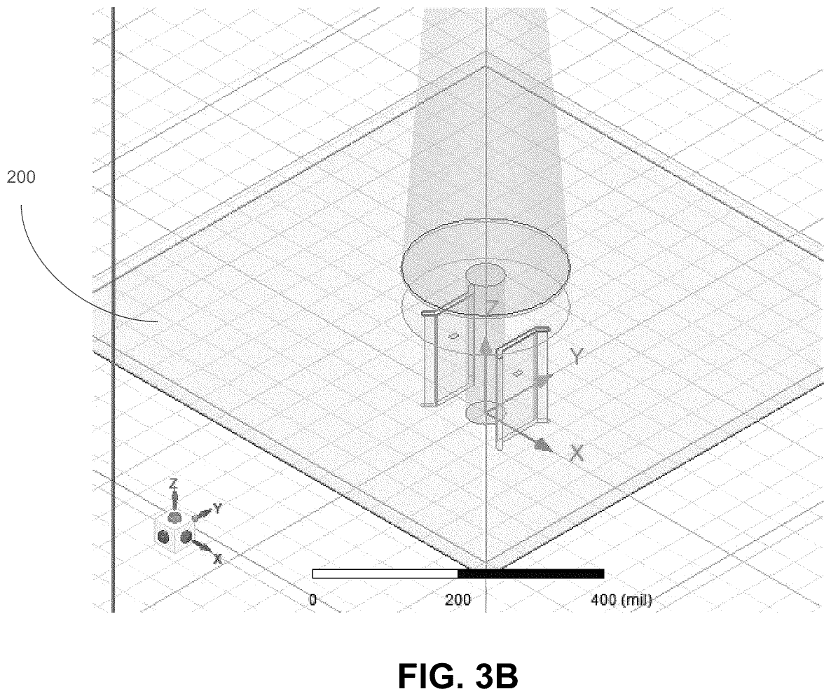

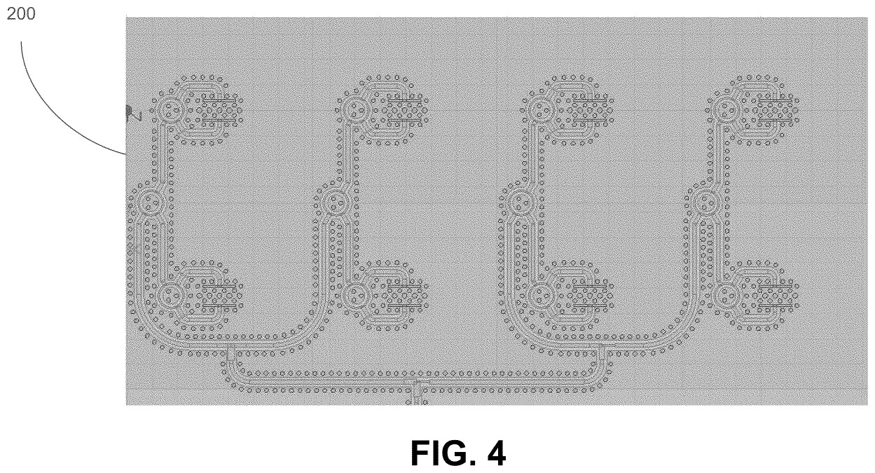

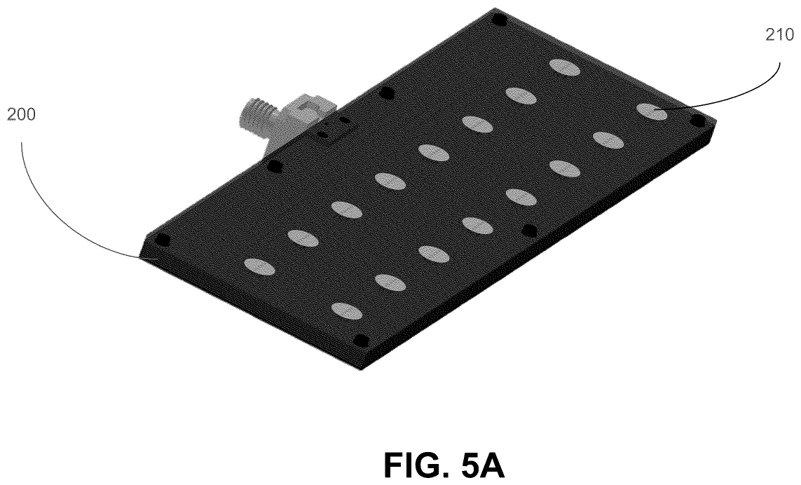

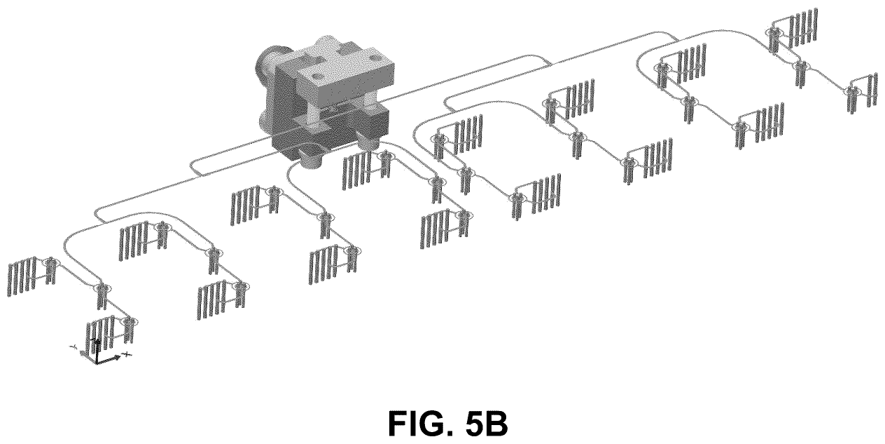

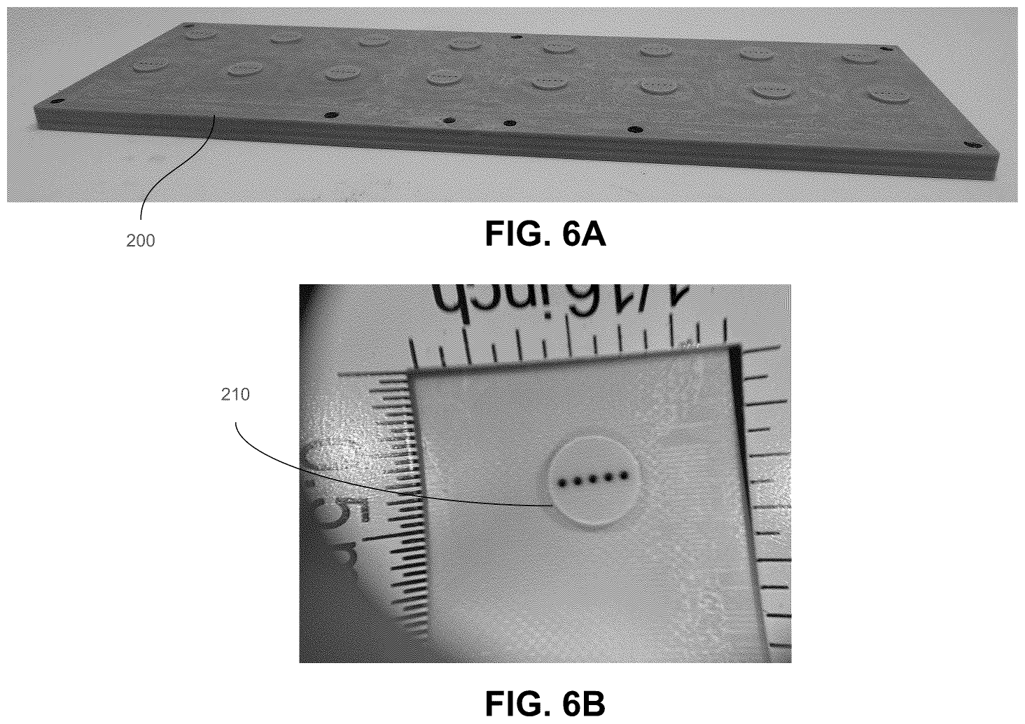

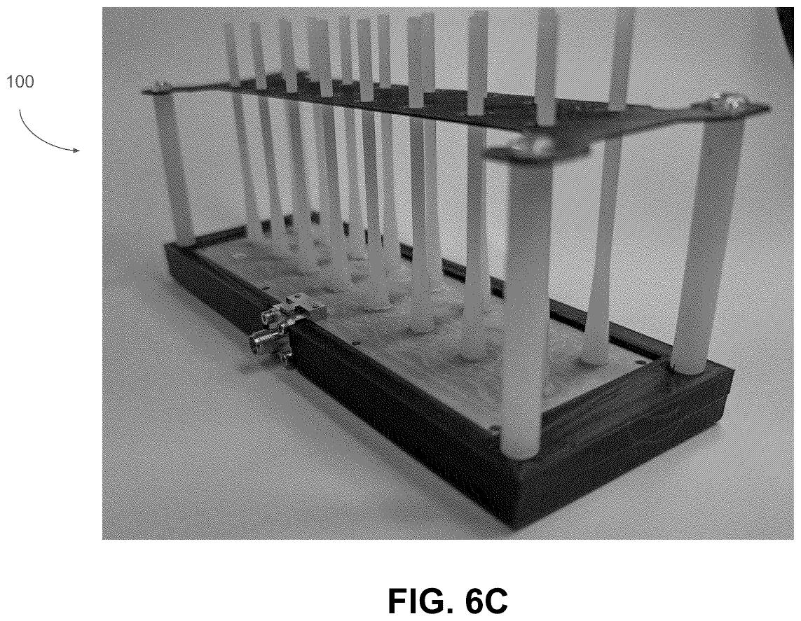

In some embodiments, each dielectric antenna of the plurality of dielectric antennas may be fed by one or more slots. The one or more slots may be configured to apply power to the plurality of dielectric antennas such that each antenna is excited by the one or more slots. In some embodiments, one or more antennas of the plurality of dielectric antennas may be fed by one slot. In some embodiments, one or more antennas of the plurality of dielectric antennas may be fed by two slots. In some embodiments, one or more antennas of the plurality of dielectric antennas may be fed by any number of slots such that side lobes generated by the device are minimized. In some embodiments, each slot of the one or more slots may have a width of half of a wavelength. In some embodiments, each slot of the one or more slots may have a depth of half of a guide wavelength. Some embodiments of the various slot configurations are shown in FIGS. 3A-3B.

In some embodiments, one or more metal posts may be disposed between slots for one or more antennas of the plurality of antennas. In some embodiments, each pair of slots may comprise a metal post disposed between them. In some embodiments, each metal post of the one or more metal posts may be disposed on top of the board. In some embodiments, each metal post of the one or more metal posts may be disposed within the board. In some embodiments, each metal post of the one or more metal posts may be disposed underneath the board. In some embodiments, each metal post of the one or more metal posts may have a diameter that is manufacturable and sufficient to improve isolation between the slots. In some embodiments, each metal post of the one or more metal posts may be above the radiating surface of the slot. In some embodiments, a cross-sectional shape of each metal post of the one or more metal posts may comprise a circle, a rectangle, or any other polygonal shape. In some embodiments, a material of each metal post of the one or more metal posts may comprise copper, iron, gold, silver, any other metal, or a combination thereof. An example of the placement of a metal post is shown in FIG. 3B.

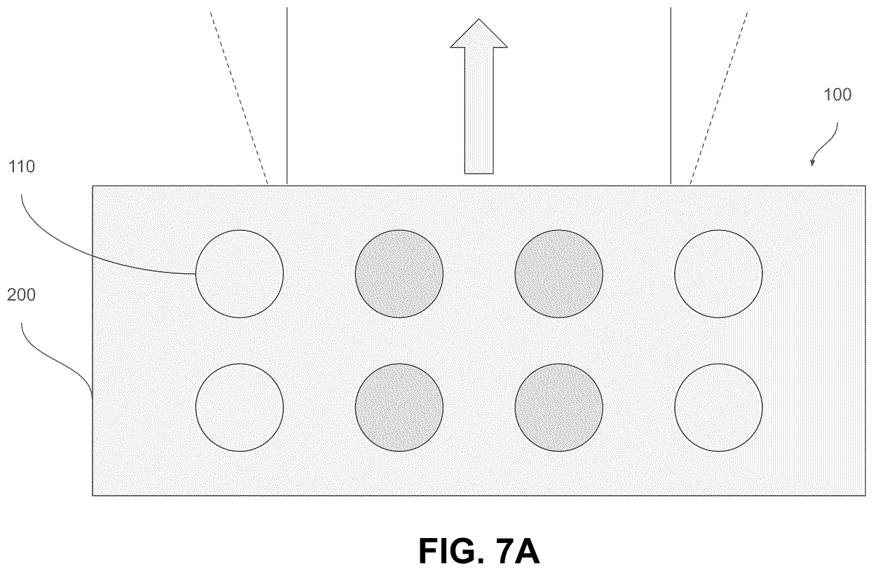

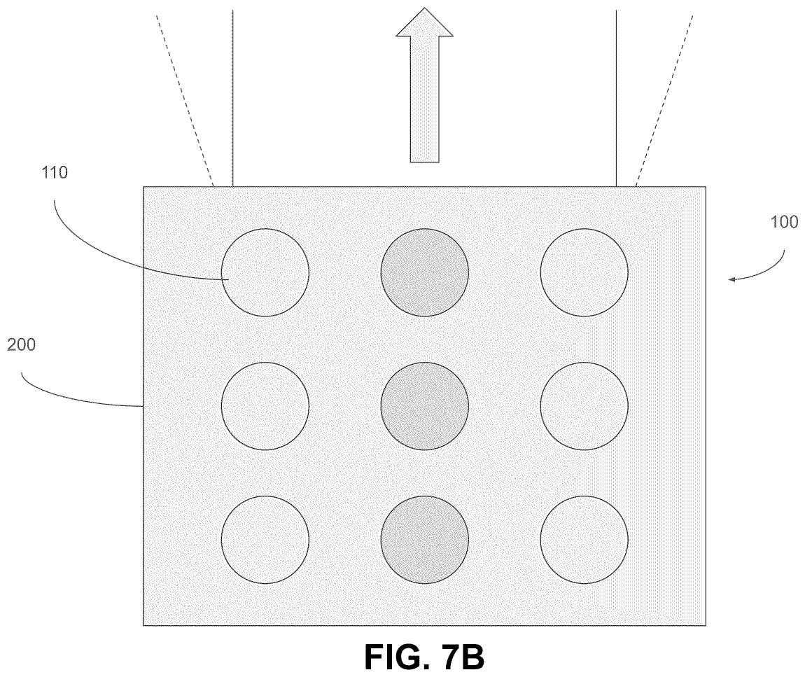

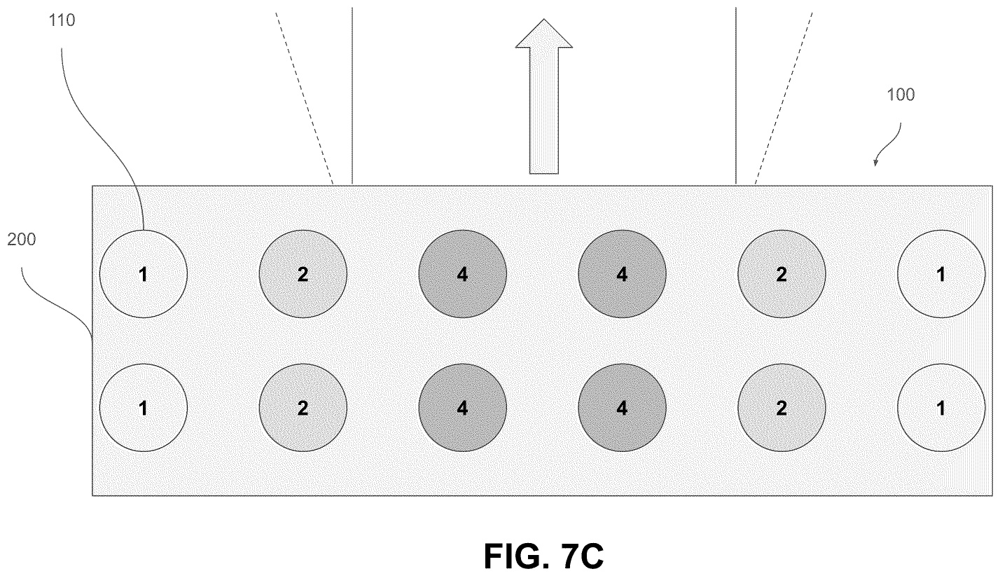

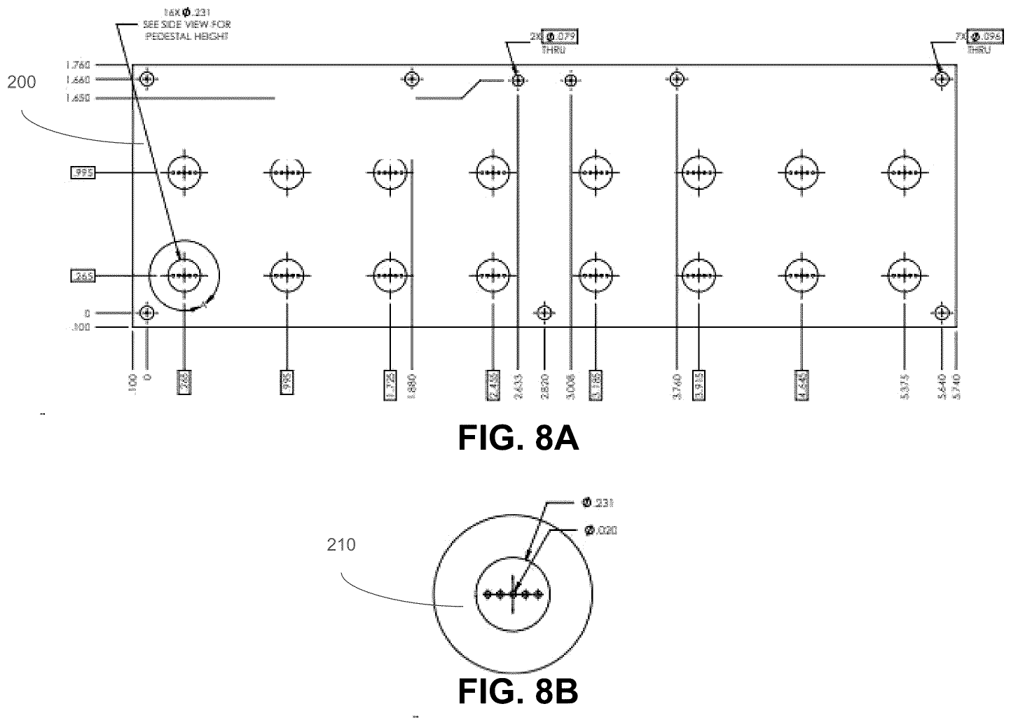

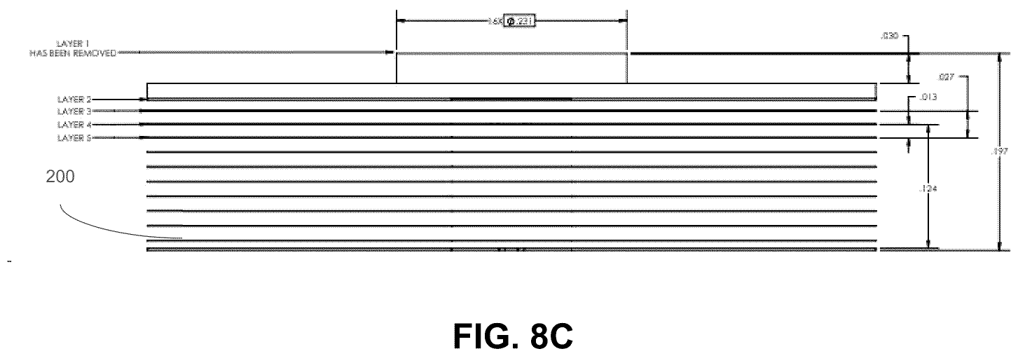

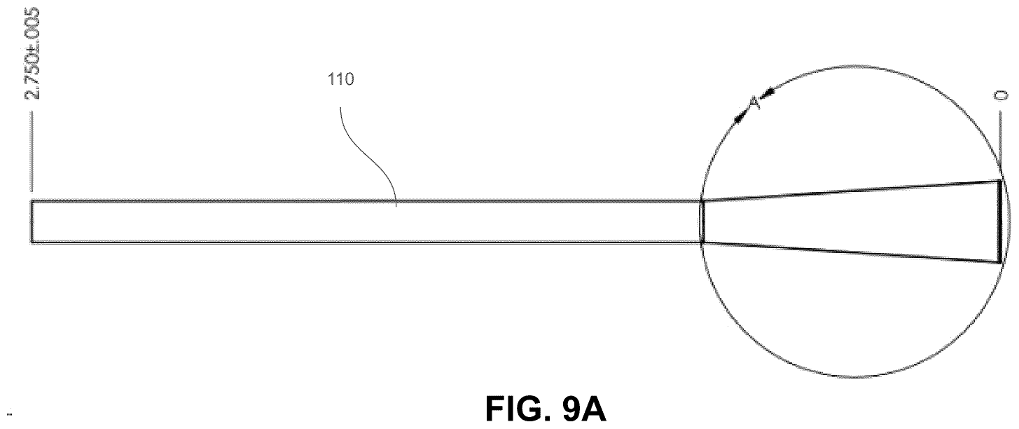

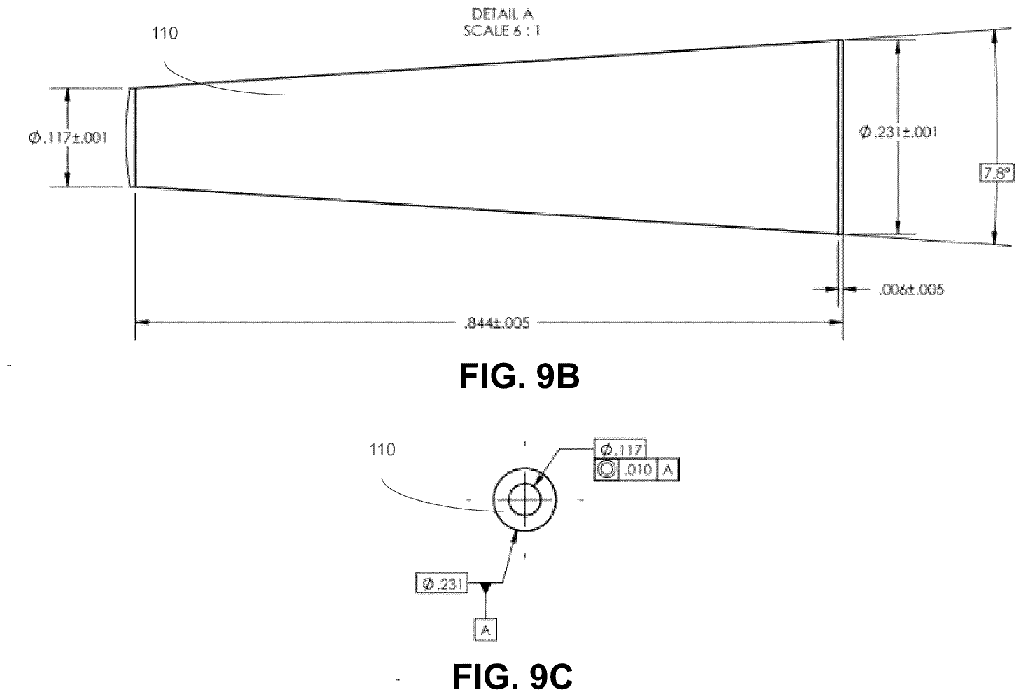

In some embodiments, different amounts of power may be applied to each antenna of the plurality of dielectric antennas by the one or more slots. In some embodiments, the amount of power directed to the plurality of dielectric antennas may comprise a bilateral gradient such that the amount of power directed to antennas at each end of the phased array is less than the amount of power directed to antennas at a center of the phased array. For example, in a phased array comprising two rows of four antennas, the first and last antennas in each row may receive less power from the one or more slots than the second and third antennas in each row. In another example, in a phased array comprising one row of five antennas, the first and last antennas in the row may receive the least amount of power, the second and fourth antennas in the row may receive the second least amount of power, and the third antenna in the row may receive the highest amount of power. A diagram of this is shown in FIG. 7C, showing an example of the change in factors of power applied to the central antennas compared to the outer antennas.

In some embodiments, this power contouring may determine a direction of signal transmission. For example, in a phased array comprising two rows of four antennas, where the first and last antennas in each row receive less power from the one or more slots than the second and third antennas in each row, the signal may be transmitted perpendicular to the array (see FIG. 7A). In another example, in a phased array comprising three rows of three antennas, wherein the first and last antennas in each row receive less power than the second antennas in each row, the signal may be transmitted in line with the center antennas (see FIG. 7B). In some embodiments, the power contouring strategy may minimize the presence of side lobes in the device of the present invention. In some embodiments, the beam profile may be focused by the inclusion of power contouring, as displayed in FIGS. 7A-7B by the solid lines (the present invention) and the dotted lines (prior system with side lobes).

The power may be contoured in symmetrical antenna pairs working from the center out to the edges, such that the power is less the closer an antenna is to the edges. In some embodiments, the plurality of dielectric antennas may all receive the same amount of power. In some embodiments, the central dielectric antenna(s) in an array may receive a first amount of power, the next-innermost symmetrical pair of antennas adjacent to the central dielectric antennas may receive a second amount of power equal to half of the first amount of power, the next-innermost symmetrical pair of antennas after the last pair may receive a third amount of power equal to half of the second amount of power, and so on.

In some embodiments, a height of an antenna of the plurality of antennas may be 0.05 to 7 inches. The height of each antenna may be adjusted for antenna gain appropriate for the particular array design. In some embodiments, different antennas in the plurality of antennas may vary to shape the beam profile. In some embodiments, a distance between pairs of antennas of the plurality of antennas may be 0.25 to 2 inches. The distance between pairs of antennas may be variable based on the gain (length) of each individual rod. The spacing may increase as the individual rod gain increases. In some embodiments, the distances between different pairs of antennas of the plurality of antennas may vary to shape the beam profile. The goal of shaping the beam profile may be to focus the shape of the beam profile to maximize gain and minimize side lobes. In some embodiments, each antenna of the plurality of dielectric antennas may have a diameter proportional to the wavelength in the rod material and inversely proportional to the square root of the rod material dielectric constant. In some embodiments, each antenna of the plurality of dielectric antennas may have a cross-sectional shape of a circle, a rectangle, or any polygonal shape.

In some embodiments, a height of each antenna of the plurality of dielectric antennas may be affected by a dielectric constant of a material for each antenna. In some embodiments, a material of each antenna of the plurality of dielectric antennas may comprise ceramic, plastic, mica, glass, quartz, any other dielectric material, or a combination thereof. In some embodiments, a material of each antenna of the plurality of dielectric antennas may be dependent on a target dielectric coefficient of the material. In some embodiments, the target dielectric coefficient may be 1 to 40. In some embodiments, the target dielectric coefficient may be 5 to 10. In some embodiments, the target dielectric coefficient may be 10 to 20. In some embodiments, the target dielectric coefficient may be 15 to 30. In some embodiments, different materials with different dielectric constants may be used for each antenna of the plurality of dielectric antennas to shape the beam profile.

In some embodiments, the plurality of dielectric antennas may comprise 4 to 20 antennas. In some embodiments, the plurality of dielectric antennas may be arranged in a single row. In some embodiments, the plurality of dielectric antennas may be arranged in a plurality of rows, each row comprising a plurality of dielectric antennas. In some embodiments, each row of the plurality of rows may comprise an equal number of dielectric antennas. In some embodiments, one or more rows of the plurality of rows may comprise a different number of dielectric antennas to shape the beam profile. In some embodiments, a perimeter around the plurality of dielectric antennas may comprise a rectangle shape, a triangular shape, or any other polygonal shape.

In some embodiments, the board may comprise a length equal to the quantity of rods times the rod spacing. In some embodiments, the board may comprise a width equal to the number of rods in a row of dielectric antennas times the spacing between the rods. In some embodiments, the board may comprise a thickness of at least a half wavelength in the board material of the operating frequency. In some embodiments, a material of the board may comprise silicon, resin, glass, polystyrene, polyisocyanurate, polyurethane, perlite, any other insulating material, or a combination thereof.

In some embodiments, each pedestal of the one or more pedestals may comprise a diameter encompassing the one or more slots. In some embodiments, each pedestal of the one or more pedestals may comprise a height equal to the metal post. In some embodiments, each pedestal of the one or more pedestals may be coupled to one or more slots such that an electrical connection is made. In some embodiments, a material of each pedestal of the one or more pedestals may comprise silicon, resin, glass, polystyrene, polyisocyanurate, polyurethane, perlite, any other insulating material, or a combination thereof.

In some embodiments, the device of the present invention may be used for a plurality of applications, such as radar, point-to-point communications, RF repeaters, etc.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A signal transmission device (100) comprising a phased array comprising a plurality of dielectric antennas (110), configured to generate a signal having a beam profile based on one or more properties of the plurality of dielectric antennas (110).

2. The device (100) of claim 1, wherein the one or more properties comprise a height of one or more antennas of the plurality of dielectric antennas (110).

3. The device (100) of claim 1, wherein the one or more properties comprise a distance between the plurality of dielectric antennas (110).

4. The device (100) of claim 1, wherein the one or more properties comprise an amount of power directed to each antenna of the plurality of dielectric antennas (110).

5. The device (100) of claim 4, wherein the amount of power directed to the plurality of dielectric antennas (110) comprises a bilateral gradient such that the amount of power directed to antennas at each end of the phased array is less than the amount of power directed to antennas at a center of the phased array.

6. The device (100) of claim 1, wherein the beam profile is further affected by a dielectric constant of each antenna.

7. The device (100) of claim 1, wherein one or more antennas of the plurality of dielectric antennas (110) are configured to be fed by a slot.

8. The device (100) of claim 1, wherein one or more antennas of the plurality of dielectric antennas (110) are configured to be fed by two slots.

9. The device (100) of claim 8, wherein each antenna of the one or more antennas configured to be fed by two slots comprises a center post disposed between the two slots.

10. The device (100) of claim 1, wherein the plurality of dielectric antennas (110) are arranged in one or more rows such that a perimeter around the plurality of dielectric antennas (110) has a rectangular shape.

11. The device (100) of claim 1, wherein the plurality of dielectric antennas (110) comprises 4 to 20 antennas.

12. A method for assembling a signal transmission device (100) comprising:
a. determining an intended beam profile based on an application;
b. fabricating a board (200) comprising a plurality of pedestals (210), wherein a distance between the plurality of pedestals (210) is based on the intended beam profile; and
c. attaching a plurality of dielectric antennas (110) to the plurality of pedestals (210) such that a dielectric antenna is attached to each pedestal of the plurality of pedestals (210) to form a phased array, wherein a height of each antenna of the plurality of dielectric antennas (110) is based on the intended beam profile.

13. The method of claim 12 further comprising directing an amount of power to each antenna of the plurality of dielectric antennas (110) based on the intended beam profile.

14. The method of claim 13, wherein the amount of power directed to the plurality of dielectric antennas (110) comprises a bilateral gradient such that the amount of power directed to antennas at each end of the phased array is less than the amount of power directed to antennas at a center of the phased array.

15. The method of claim 12, wherein a dielectric constant of each antenna of the plurality of dielectric antennas (110) is based on the intended beam profile.

16. The method of claim 12, wherein the board (200) further comprises a plurality of slots such that each pedestal of the plurality of pedestals (210) is fed by a slot.

17. The method of claim 12, wherein the board (200) further comprises a plurality of slots such that each pedestal of the plurality of pedestals (210) is fed by two slots.

18. The method of claim 17, wherein the board (200) further comprises a plurality of center posts such that, for each pedestal, a center post is disposed between the two slots.

19. The method of claim 12, wherein the plurality of pedestals (210) are arranged in one or more rows such that a perimeter around the plurality of pedestals (210) has a rectangular shape.

20. A signal transmission device (100) comprising a phased array comprising a plurality of dielectric antennas (110), configured to generate a signal having a beam profile based on a height of one or more antennas of the plurality of dielectric antennas (110), a distance between the plurality of dielectric antennas, an amount of power directed to each antenna of the plurality of dielectric antennas (110), a dielectric constant of each antenna of the plurality of dielectric antennas (110), or a combination thereof.
